(19) United States
(12) Patent Application Publication
(10) Pub. No.: US 2002/0029283 A1
(43) Pub. Date: Mar. 7, 2002

(54) Rich client application delivery

(75) Inventors: Chris Beckett, Vancouver (CA); Kris Lang, Vancouver (CA)

Correspondence Address: POLSTER, LIEDER, WOODRUFF & LUCCHESI, 763 SOUTH NEW BALLAS ROAD, ST. LOUIS, MO, 63141-8750, US

(73) Assignee: Yummy Interactive, Inc.

(21) Appl. No.: 09/933,289

(22) Filed: Aug. 20, 2001

Related U.S. Application Data
(60) Provisional application No. 60/228,446, filed on Aug. 18, 2000.

(51) Int. Cl. G06F 15/16

(52) U.S. Cl. 709/231; 709/213

(57) ABSTRACT

The present invention provides a rich client application delivery (“RCAD”) system comprising a server computer and a client computer each connected to a computer network. The server stores a target application image and executes a RCAD server application. The target application image comprises a collection of files necessary to execute a target application. The client computer has a processor capable of executing a client application. The client application is adapted to communicate with the RCAD server application through the computer network to retrieve portions of files in response to requests by the processor to read from or write to the portion of the file. The client application is also adapted to maintain a copy of the portion of the file in a memory associated with the client computer. Finally, the client application is adapted to retrieve the portion of the file stored in the memory in response to subsequent requests by the processor to read from or write to the portion of the file.

### CROSS REFERENCE TO RELATED APPLICATIONS

This application claims priority of U.S. Provisional Patent Application Ser. No. 60/228,446, filed Aug. 18, 2000.

### BACKGROUND OF THE INVENTION

This invention relates to the delivery of program applications across the Internet including a method that avoids problems previously associated with such delivery. The method includes a software program which allows a user to start an application with as little download as possible, does not require modifications of the target applications with which it is used, and maintains the security of those applications.

Most methods that have been previously implemented, including those currently in production, have several problems. Some methods require the publisher or application services provider to change the way applications are written, or attempt to solve the problem simply by placing the applications so that they can be downloaded in their entirety. These solutions do not fully address the main problems associated with this style of delivery. Either they present security concerns, or they make the solution unworkable because of the size of the programs.

The method described herein has the following advantages over previous methods. First, no modification is required to the application software with which the program is used. Second, the security of the applications is not compromised at any time during delivery or usage, thereby securing a publisher's exclusive rights to its application. Third, program software by which the method is implemented is easy to install and use and no previous installation experience is required. Fourth, the method provides instant gratification to the user because the program starts quickly.

### SUMMARY OF THE INVENTION

The present invention provides a rich client application delivery (“RCAD”) system comprising a server computer and a client computer, both of which are connected to a computer network. The server stores a target application image and executes a RCAD server application. The target application image comprises a collection of files necessary to execute a target application. The client computer has a processor capable of executing a client application. The client application is adapted to communicate with the RCAD server application through the computer network to retrieve portions of files in response to requests by the processor to read from or write to the portion of the file. The client application is also adapted to maintain a copy of the portion of the file in a memory associated with the client computer. Finally, the client application is adapted to retrieve the portion of the file stored in the memory in response to subsequent requests by the processor to read from or write to the portion of the file.

### BRIEF DESCRIPTION OF THE DRAWINGS

FIG. 1 is a diagram representing a client computer, server computer, and computer network according to an embodiment of the present invention;

FIG. 2 is a block diagram illustrating a virtual drive portion of the system according to an alternative embodiment of the present invention;

FIG. 3 is a block diagram illustrating a caching function according to an embodiment of the present invention; and,

FIG. 4 is a flow chart illustrating the operation an embodiment of the present invention.

### DESCRIPTION OF THE PREFERRED EMBODIMENT

While the invention is susceptible of embodiment in many different forms, there is shown in the drawings and will herein be described in detail the preferred embodiments of the invention. It is to be understood that the present disclosure is to be considered only as an example of the principles of the invention. This disclosure is not intended to limit the broad aspect of the invention to the illustrated embodiments.

A Rich Client Application Delivery (“RCAD”) system is designed to allow end users to execute computer applications from across a computer network, such as the Internet. The system accomplishes this by storing program files on a centralized server and streams the application to the client's computer in bits and pieces on an as-needed basis. The RCAD system is comprised of two primary components: the server where an application image resides, and the client's computer that creates a virtual drive and actually executes the program. As the client's computer runs the program, it attempts to access file sectors. The virtual drive checks to see if the sector is located in a local cache; and if it is not, the drive makes a call to the server and retrieves the sector. Preferably, all communications between the server and the client's computer are done using the HTTP protocol over TCP/IP. These communications protocols are more commonly used to access web pages, which make them ideal protocols to maintain compatibility with a large number of firewalls and routers currently in use. A benefit of the RCAD system is its ability to run applications “as is” with little to no required modification to the application's source code.

A RCAD application is made up of a number of files. Each of these files is broken up and stored on media in the form of a series of sectors. When an application accesses a file, the application rarely requires the entire file but simply a couple of sectors. RCAD makes use of this fact by streaming only the sectors that are required and not the entire file. For example, a game may be 100 megabytes in size, but only 34 megabytes are required to start the game at the first level. RCAD streams and caches that information and loads the next level only when it is required. In this way, a program that would otherwise require 20 minutes to download before usage of the program can be running in less then 4 minutes.

The server application is thus a mix between a web server and a file server. Now, instead of delivering files, sectors are delivered. Very little intelligence is handled at the server end. The server merely responds to a request for a sector of a particular file, retrieves the sector of the file, and transmits the sector of the file to the client computer. By using the techniques now described, this has been accomplished.

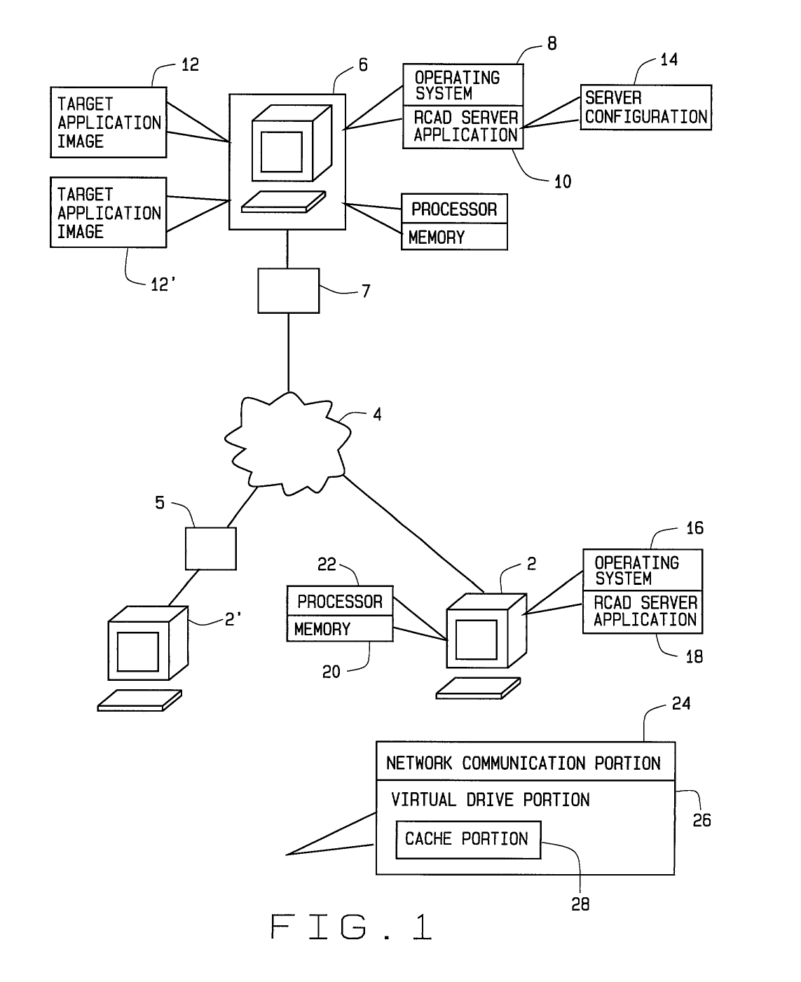

Referring to FIG. 1, the present invention provides one or more client computers 2, 2′ connected to a computer network 4. The computer network 4 can be a local area network, but is most often a wide area network such as the Internet. The client computer may be attached to the network 4 through a firewall 5 as in client computer 2′ or without a firewall as with client computer 2. Also attached to the network 4 through a firewall 7 is a server computer 6. The server computer 6 executes at least a server operating system 8 and an RCAD server application 10. The server computer 6 also contains of a copy of a target application image 12 to be transmitted and executed by the client computer 2. The server computer 6 may contain more than one target application image 12, 12′. Target application images 12 comprise the file of a target application as normally installed on a computer. An image is made by installing the application on a test computer and determining what changes were made to the test computer. All of the changes to the test computer comprise the target application image 12. The server operating system 8 is preferably Microsoft Windows 2000 Advanced Server available from the Microsoft Corporation, although any operating system may be used, such as UNIX based systems, or Microsoft Windows XP. While only one server is shown, it is contemplated that multiple servers may be implemented, as required by user load. The server computer 6 preferably uses standard protocols to offer the greatest compatibility with existing firewalls used on the Internet. Preferably, the server computer 6 uses HTTP over TCP/IP, although use of other standard or custom protocols is within the scope of the present invention. An added benefit to using the HTTP protocol allows requested application data to be cached automatically by intermediate HTTP cache servers installed by third party Internet service providers, thereby increasing apparent network speed. The RCAD server application 10 also stores a RCAD server application configuration file 14 containing information about the setup of the server, such as standard protocol related information.

The client computer 2 executes at least a client operating system 16 and a client application 18. The client operating system 16 may be any operating system. Currently, Windows based systems, such as Microsoft Windows 95, 98, Millennium Edition, NT, 2000, XP, and .NET are the most popular operating systems and are capable of executing a single client application 18 written for all systems. As such, this is the preferred client operating system 16. However, the concepts of the present invention can be implemented on other operating systems, for example, Apple Macintosh OS, LINUX, or BeOS. Additionally, game console operating systems are included, such as Sega Dreamcast Operating System, Sony PlayStation II Operating System, and the Microsoft Xbox Operating System. The only limitation of the client computer 2 is that it must be a computer (i.e. have memory and a processor), be capable of running the client application 18, and be connectable to a computer network 4.

The client application 18 is preferably a small application that resides in memory 20 of the client computer 2 and is executed by a processor 22 within the client computer 2. The client computer 2 may acquire the client application 18, for example, by downloading it from a website with a web browser or other file transfer application, installation from removable media, execution directly from removable media, or the client application 18 may be provided as an internal part of the client computer operating system 16. In the case where the client computer operating system 16 includes the client application 18, it may be executed transparently to the operator of the client computer 2.

The client application 18 comprises a network communication portion 24 and a virtual drive portion 26. The virtual drive portion 26 comprises a cache portion 28. It should be understood that the portions 24, 26, 28 are conceptual in nature and as result may not be implemented as separate, distinct portions of the present system. Such nomenclature is used purely for ease of understanding. The virtual drive portion 26 simulates one or more computer drives in the client computer memory 22. The virtual drive portion 26 preferably is a SCSI min-port driver in the client computer memory 20. The cache portion 28 holds portions of the target application image 12 which have been previously downloaded. The network communication portion 24 requests portions of the target application image 12 from the server computer 6 that have not been previously downloaded. In order to respond to a read request from the client operating system 16, the client application 18 splits the read request into discrete quantized blocks of a predetermined fixed size and for each discrete quantized block it attempts to find the block's information in the cache portion 28, if the block's data is in the cache portion 28 that data is used. If the block's data is not in the cache portion 28 then the network communication portion 24 sends a request to the server computer 6 in order to retrieve the data. A copy of the retrieved data is stored in the cache portion 28. Finally, data from each discrete quantized block is used to produce the data needed to satisfy the client operating system's 16 request.

The use of HTTP 1.1 (RFC 2616) for communication of simple sector requests from the server computer 6 to a virtual drive portion 28 is accomplished by connecting to the server and sending read requests using the HTTP “GET” command. The description of the data to be read is encoded in the uniform resource information (“URI”) field of the HTTP request. The server computer 6 interprets this field and returns the appropriate data to the client computer 2 in a valid HTTP response. Additional HTTP fields are used to provide sufficient data to any HTTP caching servers that exist between the client computer 2 and the server computer 6 on the network. The intention is that the caching servers, when provided with the right data, will cache the data to allow subsequent requests to be satisfied without querying the server computer. The server is preferably a TCP/IP server listening on port 80 that responds to simple read requests from a network communication portion 24. The server is implemented as a Win32 service (when the server computer 6 operates on a Windows based operating system) and accepts HTTP 1.1 (RFC 2616) requests for data. The server also performs security checking (described below) and usage checking to validate that the user has permission to access the data.

In operation, a client computer 2 executes the client application 18 in order to execute the target application image 12 located on the server computer 6. It is contemplated that the client application 18 can be customized for a particular target application image 12 or that the client application 18 can include a menu through which a user can select a target application image 12 to be executed from a plurality of target application images 12, 12′. In the case where a plurality of target application images 12, 12′ are available for selection, each server computer 6 can either have multiple target application images 12, 12′ to be downloaded or multiple server computers 6 can be dedicated to a particular target application image 12, 12′.

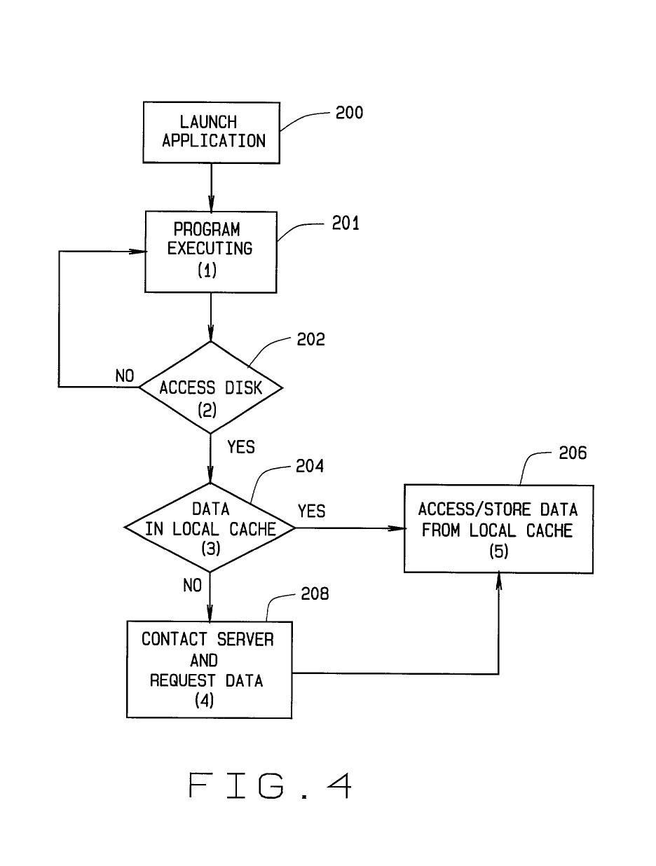

Once the target application image 12 has been determined, the client computer 2 requests information about the target application image 12 from the server computer 6. Referring to FIG. 4, the information is then loaded into the virtual drive portion 26 and the client computer 2 attempts to execute the target application image 12 by accessing the virtual drive portion 24 as in step 200. The client application 18 monitors the execution of the target application image 12 and determines whether the executing program has attempted to access the virtual drive portion 26, as in step 202. If the virtual drive portion 26 has not been accessed the operation loops to step 200. If the virtual drive portion has been accessed, the network communication portion 24 checks the cache portion 28 to determine whether the information has been previously downloaded, as in step 204. If the information has been previously downloaded, the requested information is communicated from the cache portion 28, as in step 206 and then proceeds to step 200. If the information has not been previously downloaded, the network communications portion 24 transmits a request to the server computer 6 to transmit the requested information and the server computer 6 responds by transmitting the requested information to the client computer 2, as in step 208.

Another feature of an RCAD system is to secure original authorship rights to the author of the target application image from unauthorized reproduction. This is achieved by encrypting the contents of the target application image's 12 executable file during the imaging process and decrypting the contents in the client memory 20 just prior to execution of the executable. The rest of the target application image's 12 content in the form of data files read by the executable file is protected by denying access to the original contents of these files located in the virtual drive portion 28 to processes other than the target application image 12 executable that is requesting the data. The information is denied by returning random data instead of the requested data.

In order implement this security, upon launching the target application image's 12 executable file, a one-time, time-dependent launch token is generated for the session. This allows the client application 18 to query the server computer 6 for the decryption key moments before the executable is loaded and executed. The key is not written to any form of persistent storage on the client computer 2. The encryption algorithm used to encrypt and decrypt the executable is based on the TwoFish algorithm, a symmetrical 256-bit encryption algorithm, sourced from a license-free, royalty-free third party library. The encryption/decryption key is derived from hashing a passphrase using the SHA1 algorithm, included in the same library. A portable executable (“PE”) header of the executable is interpreted and based on this information, the code section(s) are determined and encrypted using the encryption key. An import address table (“IAT”) in the PE header is modified to force inclusion of a decryption DLL library so that the executable can be decrypted in memory before it actually executes.

Additionally, the target application image 12 may include information to be imported into the client operating system 16. For example, many Windows based applications require information to be stored within the operating system registry. In this case, the target application image 12 stores information to be imported into the client operating system 16 registry and the client application 18 will cause the information to be imported.

Some programs, particularly games, that are executed require the presence of a CD-ROM (i.e. removable media) in addition to information installed to a computer's hard drive. In this instance, the program accesses two separate drives when installed locally on a computer. The CD-ROM generally contains additional music and video data, but sometimes contains program validation information. Therefore, referring to FIG. 2, in order to execute this type of program over a computer network, as in the present invention, the target application image 12 must contain an installed application image 100 and a CD image 102 in order to provide all files required to successfully execute the program. The installed application image 100 contains the files that would be normally installed to the computer's hard drive. The CD image 102 contains a copy of the information that would remain on the CD-ROM or a copy of the entire CD-ROM. In many instances the CD-ROM will contain copy protection information that should be retained in the CD image 102. In this instance, the client application 18 provides two virtual drives 26, 26′ each comprising a cache portion 28, 28′. The one virtual drive 26, 26′ provides the information from the application image 100 and the other virtual drive 26, 26′ provides information from the CD image 102.

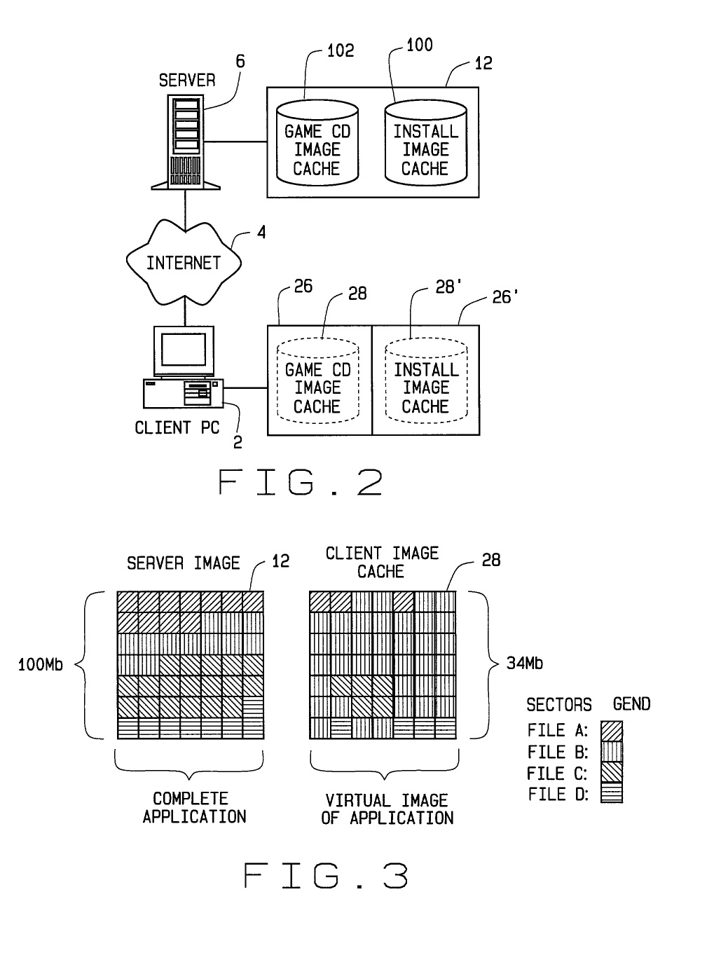

Referring to FIG. 3, it can be seen that while the target application image 12 and the cache portion 28 contain similar information they are not mirror images of each other with the cache portion contain blanks of unretrieved data. FIG. 3 shows a target application image 12 containing four files, file A, file B, file C and file D totaling 100 megabytes. The files necessary to initially execute the target application image 12 comprise only portions of the same four files totaling 34 megabytes. As seen in FIG. 3, the files are not necessarily downloaded in their entirety, are not necessarily stored in the same order in the cache portion 28 as in the application image file 12, and portions of each file are not necessarily contiguously stored in the cache portion 28.

In another embodiment, portions of the target application image 12 are divided into groups. When the user of the client computer 2 begins execution of the target application image 12, a first group of files or portions of files are transmitted to the client computer 2 that are associated with a first functionality of the target application image 12. When the user of the client computer 2 implements additional functionality of the target application 12, additional groups of files are transmitted to the client computer 2 that are associated with the further functionality. Additional functionality associated with a group of files may be, in the case of a game, files associated with a first level of the game. In the case of a word processing application, additional functionality may be files associated with a function of the application, such as a group of files necessary to implement a spell check function, a group of files necessary to implement an equation editor function, etc. This embodiment differs from the first in that, in the first embodiment, a file or portion of a file was not transmitted to the client computer by the server computer until that file or file portion was requested by the client operating system 16. In the present embodiment, the group of files associated with a function is transmitted to the client computer 2 upon request of the group by the client computer or upon request of one of the files, or a portion of one of the files, in the group. Numerous such variations can be made to the transmission scheme without departing from the scope of the present invention.

As described above, the system of the present invention transmits and receives portions of programs on an as-needed basis. As such, the network connection undergoes periods of disuse during execution of the target application image 12 when new files are not being requested. In order to implement these periods of disuse to speed the transmission of the entire target application image 12, the network communication portion 16 can use periods of network connection inactivity to download files or portions of files that may be requested by the client operating system 16 in the future. In the case of a game, after the client computer 2 has received all of the files to begin execution of the game, the network communication portion 24 may begin downloading the files which will be necessary in the future to continue the first level of the game or, if complete, begin downloading the files necessary to begin playing a second level of the game. Likewise, for any application program, during periods of disuse of the network connection, portions of the target application image 12 may be downloaded and stored in the cache portion 28 to minimize or eliminate any waiting time when the portion of the target application image 12 is required. Optimally, the network communication portion 24 can immediately cease downloading of any portions of the target application image 12 which the present system anticipates will be used in the future to process any requests for currently necessary files or portions of files of the target application image 12.

Additionally, some target application images 12, 12′ may use the network connection to implement the functionality of the program. This is especially true in the circumstance of games where players may compete over the wide area network 4. In such case, it would be disadvantageous to use the network connection to download portions of the target application image 12 that may be required in the future. In such a situation it is contemplated that the network communication portion 24 may throttle requests for an anticipatory transmission in order to avoid using the entire bandwidth of the network connection for such transmission.

In implementing the present invention, the individual application requirements for each program do not change. For example, applications that are designed to be executed on the Windows 98 operating system will still require the Windows 98 operating system or programs that require 16 MB of random access memory will still require 16 MB of random access memory. The method of the invention has been developed to deliver applications that normally could not be executed across the Internet any other way. These applications tend to be more graphic, CPU or I/O intensive.

While a specific embodiment has been illustrated and described, numerous modifications come to mind without significantly departing from the spirit of the invention, and the scope of protection is only limited by the scope of the accompanying claims.

We claim:

1. A rich client application delivery (“RCAD”) system comprising:
a server computer connected to a computer network, storing a target application image and executing a RCAD server application, wherein the target application image comprises a collection of files necessary to execute a target application;
a client computer connected to the computer network and having a processor capable of executing a client application, wherein:
the client application is adapted to communicate with the RCAD server application through the computer network to retrieve portions of files in response to requests by the processor to read from or write to the portion of the file;
the client application is adapted to maintain a copy of the portion of the file in a memory associated with the client computer;
the client application is adapted to retrieve the portion of the file stored in the memory in response to subsequent requests by the processor to read from or write to the portion of the file.

2. A method of delivering a computer application across a wide area network comprising:
providing a server computer connected to a computer network;
storing a target application image on the server computer;
executing a RCAD server application on the server computer, wherein the target application image comprises a collection of files necessary to execute a target application;
providing a client application capable of execution on a client computer;
the client application transmitting requests for at least a portion of a file to the RCAD server application on the server computer in response to requests by the client computer to read from or write to the portion of the file;
the server computer transmitting at least a portion of the requested file to the requests to retrieve portions of files;
maintaining a copy of the portion of the file in a memory associated with the client computer;
retrieving the portion of the file stored in the memory in response to subsequent requests by the client computer to read from or write to the portion of the file.

3. A rich client application delivery (“RCAD”) system comprising:
means for providing a server computer connected to a computer network;
means for storing a target application image on the server computer;
means for executing a RCAD server application on the server computer, wherein the target application image comprises a collection of files necessary to execute a target application;
means for providing a client application capable of execution on a client computer;
the client application comprising means for transmitting requests for at least a portion of a file to the RCAD server application on the server computer in response to requests by the client computer to read from or write to the portion of the file;
the server computer comprising means for transmitting at least a portion of the requested file to the requests to retrieve portions of files;
means for maintaining a copy of the portion of the file in a memory associated with the client computer;
means for retrieving the portion of the file stored in the memory in response to subsequent requests by the client computer to read from or write to the portion of the file.
